(19) United States
(12) Patent Application Publication
(10) Pub. No.: US 2025/0323742 A1
(43) Pub. Date: Oct. 16, 2025

(54) Synchronous Enhancement Method for Hypergraph Multi-agent Grouping Systems Based on Randomized Topology Switching

(71) Applicant: DALIAN UNIVERSITY OF TECHNOLOGY, Dalian (CN)

(72) Inventors: Qiang ZHANG, Dalian (CN); Yinchao YANG, Dalian (CN); Xirong XU, Dalian (CN); Pengfei WANG, Dalian (CN); Tiwei TAO, Dalian (CN)

(21) Appl. No.: 18/742,776

(22) Filed: Jun. 13, 2024

(30) Foreign Application Priority Data
Apr. 12, 2024 (CN) 202410439349.9

(51) Int. Cl. H04J 3/06; H04L 41/12

(52) U.S. Cl. CPC H04J 3/0638; H04L 41/12

(57) ABSTRACT

The present invention belongs to the technical field of complex network synchronization, and discloses a synchronous enhancement method for hypergraph multi-agent grouping systems based on randomized topology switching. The present invention innovatively introduces a randomized topology switching strategy into time-varying hypergraph multi-agent grouping systems and discusses the promoting effect of stochastic evolution of the relationship between nodes and hyperedges on the synchronizability of the systems. The stochasticity of the connection relationship provides more possibilities for information exchange among multiple agents so that the multi-agent systems can realize grouping synchronization even in the case of limited communication bandwidth or unstable network environment. The synchronous enhancement method for hypergraph multi-agent grouping systems based on randomized topology switching of the present invention improves the synchronization efficiency of the systems in the case of limited communication resources, which is of great significance for situations requiring high coordination.

### TECHNICAL FIELD

The present invention belongs to the technical field of complex network synchronization, and particularly relates to a synchronous enhancement method for hypergraph multi-agent grouping systems based on randomized topology switching.

### BACKGROUND

At present, the research and application of synchronization of multi-agent grouping systems has become a rapidly developing field. How to design a strategy that can adapt to topology changes and maintain efficient synchronization becomes a challenging problem. The research on the strategy is of great significance for situations requiring high coordination such as UAV formation flight, automated warehouse management and intelligent transportation systems. More efficient and reliable automated systems can be designed by improving the grouping synchronizability of multi-agent systems to meet increasingly complex industrial and social needs.

With the development of the hypergraph theory, multiple agents are regarded as nodes, hyperedges are formed among the agents in a task-driven approach, and hypergraphs allow multiple nodes to be connected by one hyperedge, so as to describe a more complex multi-agent relationship. Meanwhile, the synchronization of multi-agent grouping systems on the hypergraphs shows a broad development prospect. Neuhäuser et al. discussed a grouping consistent dynamical model on hypergraphs in the paper “Consensus dynamics and opinion formation on hypergraphs”. The results show how the structure of the nonlinear grouping model causes the system dynamics state to deviate from the average value. Salova et al. studied the problem of grouping synchronization on hypergraphs in the paper “Cluster synchronization on hypergraphs”, and the linear stability analysis can be simplified by constructing a projection Laplacian matrix for each hyperedge group.

However, the existing related researches are based on time static hypergraphs, i.e., the interaction structure of grouped hypergraphs is constant, while the interaction structure in current situations usually has the characteristics of time evolution. For example, in the spreading process of diseases, the infected may frequently change contactual groups due to changes in social relations. The present invention innovatively introduces a randomized topology switching strategy into hypergraph multi-agent grouping systems and discusses the promoting effect of stochastic evolution of the relationship between nodes and hyperedges on the synchronizability of the systems. The stochasticity of the connection relationship provides more possibilities for information exchange among multiple agents so that the multi-agent systems can realize grouping synchronization even in the case of limited communication bandwidth or unstable network environment.

### SUMMARY

Under the background of network topology changes and limited communication resources, hypergraph multi-agent systems face the challenge of synchronizability. Most of the existing researches focus on static or simple binary relation networks, but ignore the influence of network dynamics and resource constraints on synchronizability. Therefore, the present invention proposes a synchronous enhancement strategy for multi-agent grouping systems based on the hypergraph theory and randomized topology switching, which improves the synchronization efficiency of the systems by adjusting network stochasticity, so as to adapt to the rapidly changing network environment and meet the application requirements of efficient synchronization.

The technical solution of the present invention is as follows:
A synchronous enhancement method for time-varying hypergraph multi-agent grouping systems based on randomized topology switching, comprising the following steps:
step 1: constructing an equivalent model for a time-varying hypergraph multi-agent grouping system using a weighted projection method;
a time-varying hypergraph multi-agent grouping system composed of N nodes is divided to form two subsets which have the same number of nodes and never join, each subset is regarded as a group, intra-group and inter-group connections of multiple agents are constructed one to one in a high-order relationship respectively, and each group corresponds to one hypergraph, wherein Nis even; assuming that one hypergraph has K hyperedges and N/2 nodes, the dependencies of the nodes and the hyperedges evolve over time; the hyperedges are projected as a maximal clique by a weighted method and given different weights according to the hyperedge degree, and the hypergraph is transformed into a weighted projection network; and an equivalent weighted projection model for the time-varying hypergraph multi-agent grouping system is established as follows:

$${\dot{x}}_{1 , i} = F ( {x}_{1 , i} ) + σ {\sum }_{h : i ∈ {E}_{h}^{1} , j ∈ {E}_{h}^{1}} {\sum }_{j \neq i} ( {C}_{h h}^{1} ( t ) - 1 ) [ G ( {x}_{1 , j} ) - G ( {x}_{1 , i} ) ] + λ [ H ( {x}_{2 , i} ) - H ( {x}_{1 , i} ) ] {\dot{x}}_{2 , i} = F ( {x}_{2 , i} ) + σ {\sum }_{h : i ∈ {E}_{h}^{2} , j ∈ {E}_{h}^{2}} {\sum }_{j \neq i} ( {C}_{h h}^{2} ( t ) - 1 ) [ G ( {x}_{2 , j} ) - G ( {x}_{2 , i} ) ] + λ [ H ( {x}_{1 , i} ) - H ( {x}_{2 , i} ) ] \qquad ( 1 )$$

$$that is ,$$

$${\dot{x}}_{1 , i} = F ( {x}_{1 , i} ) - σ {\sum }_{j = 1}^{N} {L}_{ij}^{{H}_{1}} ( t ) G ( {x}_{1 , j} ) + λ [ H ( {x}_{2 , i} ) - H ( {x}_{1 , i} ) ] \\ {\dot{x}}_{2 , i} = F ( {x}_{2 , i} ) - σ {\sum }_{j = 1}^{N} {L}_{ij}^{{H}_{2}} ( t ) G ( {x}_{2 , j} ) + λ [ H ( {x}_{1 , i} ) - H ( {x}_{2 , i} ) ] \qquad ( 2 )$$

wherein F:R^{d}→R^{d} represents a dynamical equation of the nodes, G:R^{d}×R^{d}→R^{d} represents an intra-group linear coupling function, H:R^{d}×R^{d}→R^{d} represents an inter-group linear coupling function, G(x)=Gx, H(x)=Hx, σ represents intra-group coupling strength, and λ represents inter-group coupling strength; x_{l,i} represents an i^{th} agent in an I^{th} group, wherein j is another agent in the same group as i;

$${C}_{hh}^{l} ( t )$$

represents the scale or an h^{th} hyperedge Eₕ^{l} in the l^{th} group, with the value changing over time, wherein l=1 or 2; t represents a time variable; and

$${L}_{ij}^{{H}_{1}} ( t )$$

is an element of a weighted Laplacian matrix of a first group, and

$${L}_{ij}^{{H}_{2}} ( t )$$

is an element of a weighted Laplacian matrix of a second group, wherein the weighted Laplacian matrix is defined as follows:

$${L}^{{H}_{l}} , ( t ) = {D}^{l} ( t ) - {W}^{l} ( t ) \\ wherein {D}^{l} ( t ) = diag ( {\sum }_{j = 1}^{N} {W}_{1 j}^{l} ( t ) , {\sum }_{j = 1}^{N} {W}_{2 j}^{l} ( t ) , … , {\sum }_{j = 1}^{N} {W}_{Nj}^{l} ( t ) ) ; \qquad ( 3 )$$

and an element

$${W}_{ij}^{l} ( t )$$

of a weighted adjacent matrix W^{l}(t) is defined as follows:

$${W}_{ij}^{l} ( t ) = \{ \begin{matrix}{\sum }_{h} ( {C}_{hh}^{l} ( t ) - 1 ) {I}_{ih}^{l} ( t ) {I}_{jh}^{l} ( t ) = {( {I}^{l} ( t ) {\hat{C}}^{l} ( t ) {{I}^{l} ( t )}^{T} )}_{ij} - {A}_{ij}^{l} ( t ) , & i \neq j \\ 0 , & i = j\end{matrix} \qquad ( 4 )$$

wherein I^{l}(t) is an incidence matrix of the l^{th} group, and a matrix element is

$${I}_{ih}^{l} ( t ) ;$$

when the node i of the l^{th} group belongs to the hyperedge

$${E}_{h}^{l} , {I}_{ih}^{l} ( t ) = 1 , otherwise {I}_{ih}^{l} ( t ) = 0 ;$$

$${A}_{ij}^{l} ( t ) = {I}_{ih}^{l} ( t ) {{I}_{jh}^{l}}^{T} ( t ) ;$$

and Ĉ^{l}(t) is a diagonal matrix whose nonzero term is the same as the diagonal element of I^{l}(t)^{T}I^{l}(t);
step 2: setting evolution rules, stochasticity measurement indexes and intra-group synchronizability measurement indexes, and designing evolution rules of the hypergraph multi-agent grouping system;
(1) stochasticity measurement indexes of evolution rules: the regulation of stochasticity of the time-varying hypergraph multi-agent grouping system is achieved by introducing two variables: the first is the number of pairs of unequal stochastic elements exchanged simultaneously in the incidence matrix, and the second is the hypergraph switching frequency f, each time the hypergraphs are switched, the incidence matrix thereof changes randomly according to the IN value; and the changes in the IN and f values mean changes in the stochasticity of the hypergraphs;
(2) intra-group synchronizability measurement indexes: intra-group synchronizability is measured from three aspects: intra-group synchronization errors, intra-group synchronization critical time and intra-group synchronization critical coupling strength; the improvement of the intra-group synchronizability is represented in the decrease of the three indexes; and an intra-group synchronization error E is introduced:

$$E = {E}_{1} + {E}_{2} , {E}_{1} = \frac{1}{N} {\sum }_{i = 1}^{N} ‖ {x}_{1 , i} - {\overline{x}}_{1} ‖ , {E}_{2} = \frac{1}{N} {\sum }_{i = 1}^{N} ‖ {x}_{2 , i} - {\overline{x}}_{2} ‖ \qquad ( 5 )$$

wherein E₁ and E₂ represent synchronization errors of two groups of time-varying hypergraphs respectively, and the threshold of the synchronization errors is set to 10⁻⁵;
(3) design of evolution rules of the hypergraph multi-agent grouping system:
rule 1: each group of hypergraphs are switched at frequency f, and different pairs of stochastic elements in the incidence matrix are exchanged simultaneously at each switch, avoiding repeated selection of the same element;
rule 2: each row and each column of the incidence matrix are not zero at any moment, ensuring that each node is in at least one hyperedge and each hyperedge comprises at least one node;
rule 3: the dynamic changes of the incidence matrix are inheritable, and each change starts with a previous state;
rule 4: when elements to be exchanged in the incidence matrix are selected, it is necessary to make sure that the exchange will not cause any column to become a logical subset of another column, otherwise it is necessary to re-select;
step 3: under the conditions of long term evolution and hypergraph fast switching, obtaining time-averaged approximate equations according to the equivalent weighted projection model; analyzing necessary conditions for the linear stability of the time-averaged approximate equations using a master stabilizing function method; and by constructing an error equation and a Lyapunov function to judge the global stability of the time-averaged approximate equations, establishing global synchronization criteria;
step 3.1: letting

$$\frac{1}{T} {\int }_{t}^{t + T} {L}^{{H}_{1}} ( τ ) d τ = {\overline{L}}^{{H}_{1}} and \frac{1}{T} {\int }_{t}^{t + T} {L}^{{H}_{2}} ( τ ) d τ = {\overline{L}}^{{H}_{2}} ,$$

processing the equivalent weighted projection model using the time-averaged approximate equations to obtain a time approximate equation:

$${\dot{x}}_{1 , i} = F ( {x}_{1 , i} ) - σ {\sum }_{j = 1}^{N} {\overline{L}}_{ij}^{{H}_{1}} G ( {x}_{1 , j} ) + λ [ H ( {x}_{2 , i} ) - H ( {x}_{1 , i} ) ] \qquad ( 6 )$$

$${\dot{x}}_{2 , i} = F ( {x}_{2 , i} ) - σ {\sum }_{j = 1}^{N} {\overline{L}}_{ij}^{{H}_{2}} G ( {x}_{2 , j} ) + λ [ H ( {x}_{1 , i} ) - H ( {x}_{2 , i} ) ]$$

wherein T is the evolution time of the equivalent weighted projection model under the sequential evolution rules 1-4; L^{H}^{₁} is the weighted Laplacian matrix of the first group; and L^{H}^{₂} is the weighted Laplacian matrix of the second group;
step 3.2: letting x_{1,S} and X_{2,S} represent synchronization state variables of the first group and the second group respectively, and studying dynamical equations of perturbation vectors δx_{1,i}=x_{1,i}−x_{1,S} and δx_{2,i}=x_{2,i}−x_{2,S}, thereby obtaining a linearized equation from formula (6):

$$δ {\dot{x}}_{1 , i} = JF ( {x}_{1 , S} ) δ {x}_{1 , i} - σ {\sum }_{j = 1}^{N} {\overline{L}}_{ij}^{{H}_{1}} JG ( {x}_{1 , S} ) δ {x}_{1 , i} + λ [ JH ( {x}_{2 , S} ) δ {x}_{2 , i} - JH ( {x}_{1 , S} ) δ {x}_{1 , i} ] \qquad ( 7 )$$

$$δ {\dot{x}}_{2 , i} = JF ( {x}_{2 , S} ) δ {x}_{1 , i} - σ {\sum }_{j = 1}^{N} {\overline{L}}_{ij}^{{H}_{2}} JG ( {x}_{2 , S} ) δ {x}_{2 , j} + λ [ JH ( {x}_{1 , S} ) δ {x}_{1 , i} - JH ( {x}_{2 , S} ) δ {x}_{2 , i} ]$$

wherein J is a Jacobi operator;
assuming that L̅^{H}^{₁} and L̅^{H}^{₂} are interchangeable, L̅^{H}^{₁} and L̅^{H}^{₂} are diagonalized under the same basis, L̅^{H}^{₁} and L̅^{H}^{₂} share a group of eigenvectors vᵢ,i=1, . . . , N, and a matrix composed of the eigenvectors is denoted as V=[v₁, v₂, . . . , v_{N}], then

$${Λ}_{1} = {V}^{- 1} {\overline{L}}^{{H}_{1}} V = diag \{ 0 = {γ}_{1} \leq {γ}_{2} \leq ⋯ \leq {γ}_{N} \}$$

$${Λ}_{2} = {V}^{- 1} {\overline{L}}^{{H}_{2}} V = diag \{ 0 = {ρ}_{1} \leq {ρ}_{2} \leq ⋯ \leq {ρ}_{N} \}$$

$$δ {x}_{1} = {[ δ {x}_{1 , 1}^{T} , δ {x}_{1 , 2}^{T} , ⋯ , δ {x}_{1 , N}^{T} ]}^{T} and δ {x}_{2} = {[ δ {x}_{2 , 1}^{T} , δ {x}_{2 , 2}^{T} , ⋯ , δ {x}_{2 , N}^{T} ]}^{T}$$

are introduced; and δxₗ is projected on V and denoted as ξ^{(l)}=(V⁻¹⊗I_{d})δxₗ, wherein I_{d} represents a unit matrix, thereby obtaining a master stabilizing equation:

$${\dot{ξ}}_{i}^{( 1 )} = JF ( {x}_{1 , S} ) {ξ}_{i}^{( 1 )} - {σγ}_{i} JG {ξ}_{i}^{( 1 )} + λ [ JH ( {x}_{2 , S} ) {ξ}_{i}^{( 2 )} - JH ( {x}_{1 , S} ) {ξ}_{i}^{( 1 )} ] \qquad ( 8 )$$

$${\dot{ξ}}_{i}^{( 2 )} = JF ( {x}_{2 S} ) {ξ}_{i}^{( 2 )} - σ {ρ}_{i} JG {ξ}_{i}^{( 2 )} + λ [ JH ( {x}_{1 , S} ) {ξ}_{i}^{( 1 )} - JH ( {x}_{2 , S} ) {ξ}_{i}^{( 2 )} ]$$

wherein

$${ξ}_{1}^{( l )}$$

represents motion along intra-group synchronization manifold, and other

$${ξ}_{i}^{( l )}$$

represents evolution of different modes intersecting synchronization manifold; and through the master stabilizing equation and an equation satisfied by nonlinear synchronization solutions:

$${\dot{x}}_{1 , S} = F ( {x}_{1 , S} ) + λ [ H ( {x}_{2 , S} ) - H ( {x}_{1 , S} ) ] \qquad ( 9 )$$

$${\dot{x}}_{2 , S} = F ( {x}_{2 , S} ) + λ [ H ( {x}_{1 , S} ) - H ( {x}_{2 , S} ) ]$$

the largest transverse Lyapunov exponents of two subequations in the master stabilizing equation are calculated respectively:

$${Ω}_{1} ( σ , λ , {Λ}_{1} ) = {lim}_{t \to 0} \frac{1}{t} ln \vert {ξ}_{i}^{〈 1 )} {ξ}_{i}^{〈 1 )} ( 0 ) \vert {max}_{1}^{} \qquad ( 10 )$$

$${Ω}_{2} ( σ , λ , {Λ}_{2} ) = {lim}_{t \to 0} \frac{1}{t} ln \vert {ξ}_{i}^{〈 2 )} {ξ}_{i}^{〈 2 )} ( 0 ) \vert {max}_{2}^{}$$

wherein

$${ξ}_{i}^{( 1 )} ( 0 ) and {ξ}_{i}^{( 2 )} ( 0 )$$

represent initial values of the master stabilizing equation, and

$${max}_{l}^{}$$

represents the maximum value obtained when i traverses all the nodes in the group; the necessary conditions for the time approximate equation to achieve linear stability are Ω₁<0 and Ω₂<0; when the inter-group coupling strength λ is constant, the intra-group synchronization critical coupling strength is obtained according to Ω₁=0 and Ω₂=0; and the time when the system achieves intra-group synchronization errors less than the threshold value 10⁻⁵ for the first time is recorded as the intra-group synchronization critical time, and the value thereof is given by numerical simulation according to formula (5);
step 3.3: according to the time approximate equation and formula (9), obtaining an error equation:

$$\{ \begin{matrix}δ {x}_{1} = F ( {x}_{1 , i} ) - F ( {x}_{1 , S} ) - σ {\sum }_{j = 1}^{N} {\overline{L}}_{ij}^{{H}_{1}} G ( δ {x}_{1 , j} ) + λ H ( δ {x}_{2 , i} - δ {x}_{1 , i} ) \\ δ {\dot{x}}_{2 , i} = F ( {x}_{2 , i} ) - F ( {x}_{2 , S} ) - σ {\sum }_{j = 1}^{N} {\overline{L}}_{ij}^{{H}_{2}} G ( δ {x}_{2 , j} ) + λ H ( δ {x}_{1 , i} - δ {x}_{2 , i} )\end{matrix} \qquad ( 11 )$$

a Lyapunov function is constructed:

$$Y ( t ) = {Y}_{1} ( t ) + {Y}_{2} ( t ) , wherein {Y}_{1} ( t ) = \frac{1}{2} {\sum }_{i = 1}^{N} {( δ {x}_{1 , i} )}^{T} δ {x}_{1 , i} ,$$

$$and {Y}_{2} ( t ) = \frac{1}{2} {\sum }_{i = 1}^{N} {( δ {x}_{2 , i} )}^{T} δ {x}_{2 , i} ;$$

a constant M is set as the Lipschitz constant of the function

$$F ( \cdot ) , \overline{L} = ( \begin{matrix}{\overline{L}}^{{H}_{1}} & 0 \\ 0 & {\overline{L}}^{{H}_{2}}\end{matrix} ) ∈ {R}^{2 N \times 2 N} , Q = ( \begin{matrix}- {I}_{N} & {I}_{N} \\ {I}_{N} & - {I}_{N}\end{matrix} ) ,$$

$$and δx = [ {( δ {x}_{1} )}^{T} , {( δ {x}_{2} )}^{T} ] ∈ {R}^{2 dN} ; {I}_{N} , {I}_{2 N} and {I}_{2 dN}$$

represent unit matrixes of N×N, 2N×2N and 2dN×2dN respectively; and through calculation,

$$\begin{matrix}\dot{Y} ( t ) \leq {M ( δ x )}^{T} δ x - {σ ( δ x )}^{T} ( \overline{L} ⊗ G ) δ x - {d ( δ x )}^{T} ( {I}_{2 N} ⊗ H ) δx + \\ λ {( δ x )}^{T} [ ( {I}_{2 N} ( \begin{matrix}0 & {I}_{N} \\ {I}_{N} & 0\end{matrix} ) ) ⊗ H ] δ x \\ = {( δ x )}^{T} [ {MI}_{2 d N} - σ ( \overline{L} ⊗ G ) + λ ( Q ⊗ H ) ] δ x\end{matrix} \qquad ( 12 )$$

it is noted that a matrix v exists so that Λ=V⁻¹L̅V, wherein Λ is a diagonal matrix composed of

$${γ}_{i} and {ρ}_{i} , 0 = {γ}_{1} \leq {γ}_{2} \leq … \leq {γ}_{N} , and 0 = {ρ}_{1} \leq {ρ}_{2} \leq … \leq {ρ}_{N} ;$$

$$ξ = ( {V}^{- 1} ⊗ {I}_{d} ) δ x = {( {ξ}_{1}^{T} , {ξ}_{2}^{T} , … , {ξ}_{2 N}^{T} )}^{T} ,$$

wherein ξᵢ is a d-dimensional vector; and

$$σ = {σ}_{0} + 1 = \frac{1}{{\partial }_{2} ( Λ ⊗ G )} ( M + λ {\partial }_{max} ( ( {V}^{- 1} QV ) ⊗ H ) ) + 1 ,$$

thereby obtaining:

$$( 13 )$$

$$\dot{Y} ( t ) \leq M {ξ}^{T} ξ - σ {ξ}^{T} ( Λ ⊗ G ) ξ + ) {ξ}^{T} ( ( {V}^{- 1} QV ) ⊗ H ) ξ = - {\partial }_{2} ( Λ ⊗ G ) {( δ x )}^{T} δ x$$

wherein ∂₂(Λ⊗G) represents the second minimum eigenvalue of Λ⊗G, and ∂ₘₐₓ((V⁻¹ [symbol] V)⊗H) represents the largest eigenvalue of (V⁻¹ [symbol] V)⊗H; global synchronization criteria are determined by

$${σ}_{0} = \frac{1}{{\partial }_{2} ( Λ ⊗ G )} ( M + λ {\partial }_{max} ( ( {V}^{- 1} QV ) ⊗ H ) ) ; and when σ > {σ}_{0} ,$$

the hypergraph multi-agent grouping system realizes global intra-group synchronization;
the relationship between stochasticity and synchronizability of the model is verified by numerical experiments combined with necessary conditions for the linear stability obtained in step 3 and the global synchronization criteria as well as the three indexes of intra-group synchronization errors, intra-group synchronization critical time and intra-group synchronization critical coupling strength designed in step 2.

The present invention has the following beneficial effects: the synchronous enhancement method for hypergraph multi-agent grouping systems based on randomized topology switching improves the synchronization efficiency of the systems in the case of limited communication resources, which is of great significance for situations requiring high coordination such as UAV formation flight, automated warehouse management and intelligent transportation systems. By introducing stochasticity, the information exchange among multiple agents can adapt to the unstable network environment more flexibly, so as to realize grouping synchronization.

### DESCRIPTION OF DRAWINGS

FIG. 1 is a flow chart of the present invention.

FIG. 2 is a schematic diagram of a time-varying hypergraph multi-agent grouping system and hypergraph stochastic evolution of the present invention, wherein ovals represent hyperedges, and circles represent nodes. (a) is a schematic diagram of intra-group and inter-group connections of a time-varying hypergraph multi-agent grouping system; and (b) is a schematic diagram of evolution of a time-varying hypergraph multi-agent grouping system.

FIG. 3 shows the influence of an IN value of a 20-node short term evolution hypergraph multi-agent grouping system of the present invention on intra-group synchronization critical coupling strength and a synchronization region. (a)-(d) and (e)-(h) represent heat maps of intra-group synchronization errors under the conditions of consistent stochastic variation and independent stochastic variation of two groups of hypergraphs respectively, and the curve is a boundary curve with the largest Lyapunov exponent equal to 0. The experimental results obtained when IN is 1, 2, 3 or 4 are shown from left to right.

FIG. 4 shows the influence of stochasticity of a 20-node short term evolution hypergraph multi-agent grouping system of the present invention on intra-group synchronization errors. (a) shows a variation trend of intra-group synchronization errors with the switching frequency f and IN under the condition of consistent stochastic variation of two groups of hypergraphs. (b) shows a variation trend of intra-group synchronization errors with the switching frequency f and IN under the condition of independent stochastic variation of two groups of hypergraphs, and the curve in (b) is slightly lower than that in (a) on the whole. Other parameters are fixed to σ=0.02 and λ=0.01.

FIG. 5 shows the influence of stochasticity of a 20-node short term evolution hypergraph multi-agent grouping system of the present invention on intra-group synchronization critical time. (a) shows a variation trend of intra-group synchronization critical time with IN and funder the condition of consistent stochastic variation of two groups of hypergraphs. (b) shows a variation trend of intra-group synchronization critical time with IN and f under the condition of independent stochastic variation of two groups of hypergraphs. Other parameters are fixed to σ=0.02 and λ=0.01.

FIG. 6 shows the influence of stochasticity of a 200-node short term evolution hypergraph multi-agent grouping system of the present invention on intra-group synchronization critical coupling strength, and the higher the intra-group synchronization critical coupling strength is, the higher the coupling strength threshold required for hypergraphs to achieve intra-group synchronization is. (a) shows consistent stochastic variation of two groups of hypergraphs. (b) shows independent stochastic variation of two groups of hypergraphs. The inter-group coupling strength is fixed to λ=0.01.

FIG. 7 shows the influence of stochasticity of a 200-node short term evolution hypergraph multi-agent grouping system of the present invention on intra-group synchronization critical time, and the longer the intra-group synchronization critical time is, the longer the time required for hypergraphs to achieve intra-group synchronization is. (a) shows a variation trend of intra-group synchronization critical time with IN and f under the condition of consistent stochastic variation of two groups of hypergraphs. (b) shows a variation trend of intra-group synchronization critical time with IN and f under the condition of independent stochastic variation of two groups of hypergraphs. The coupling strength is fixed to σ=0.6 and λ=0.01.

FIG. 8 shows the influence of stochasticity of a 200-node short term evolution hypergraph multi-agent grouping system of the present invention on intra-group synchronization errors, and the larger the intra-group synchronization error is, the lower the intra-group synchronizability of hypergraphs is. (a) shows consistent stochastic variation of two groups of hypergraphs. (b) shows independent stochastic variation of two groups of hypergraphs. The coupling strength is fixed to σ=0.3 and λ=0.01.

FIG. 9 shows heat maps of intra-group synchronization errors of time-averaged approximate equations corresponding to a long term evolution fast switching hypergraph multi-agent grouping system of the present invention. Intra-group synchronization regions of the time-averaged approximate equations can be determined in combination with a curve with the Lyapunov exponent equal to 0 and a region with the intra-group synchronization error smaller than the threshold. (a) and (b) represent variations of intra-group synchronization errors with coupling strength at the number of nodes N=20 and N=200 respectively.

FIG. 10 shows time series graphs of intra-group synchronization errors of time-averaged approximate equations corresponding to a long term evolution fast switching hypergraph multi-agent grouping system of the present invention. (a) shows evolution of intra-group synchronization errors at the coupling strength threshold over time at N=20. (b) shows evolution of intra-group synchronization errors at the coupling strength threshold over time at N=200. The inter-group coupling strength is λ=0.01.

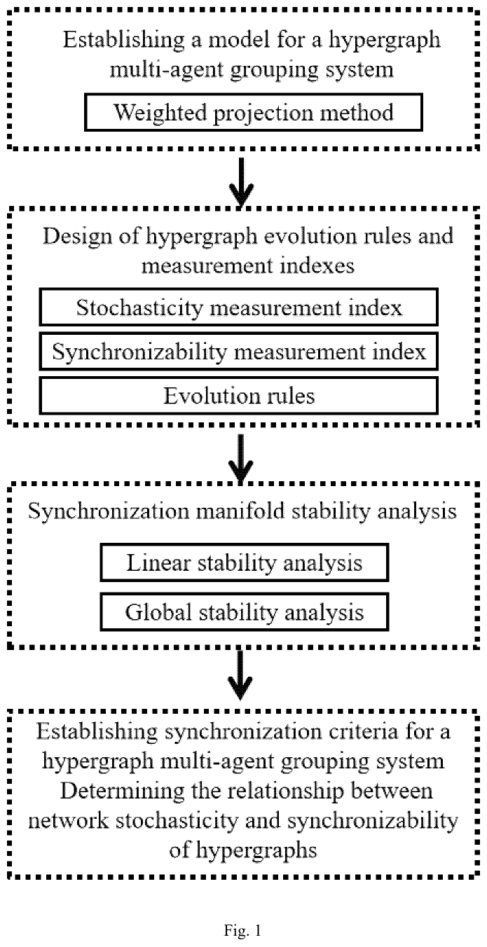

### DETAILED DESCRIPTION

Specific embodiments of the present invention are further described below in combination with the drawings and the technical solution.

Firstly, a grouping system based on time-varying hypergraphs and composed of N agents is considered, and two groups of time-varying hypergraphs are defined as H₁(t)=(V₁, E₁)(t)) and H₂(t)=(V₂, E₂(t)) respectively, wherein |V₁|=|V₂|=N/2, and |E₁(t)|=|E₂(t)=K, i.e., the two groups of time-varying hypergraphs have the same number of nodes and hyperedges, and inter-group connections are constructed one to one and do not change over time. The nodes in the two groups of time-varying hypergraphs are represented as Xₗ=(x_{l,1}, x_{1,2}, . . . , x_{l,N}), x_{l,i}∈R^{d} and i=1, 2, . . . , N; l=1, 2. An element defining a weighted adjacent matrix W^{l}(t) is defined as follows:

$${W}_{ij}^{l} ( t ) = \{ \begin{matrix}{\sum }_{h} ( {C}_{hh}^{l} ( t ) - 1 ) {I}_{ih}^{l} ( t ) {I}_{jh}^{l} ( t ) = {( {I}^{l} ( t ) {\hat{C}}^{l} ( t ) {{I}^{l} ( t )}^{T} )}_{ij} - {A}_{ij}^{l} ( t ) , & i \neq j \\ 0 , & i = j\end{matrix} \qquad ( 1 )$$

wherein I^{l}(t) is the incidence matrix of an lth group of, and a matrix element is

$${I}_{ih}^{l} ( t ) ;$$

when the node i of the l^{th} group belongs to the hyperedge

$${E}_{h}^{l} , {I}_{ih}^{l} ( t ) = 1 , otherwise {I}_{ih}^{l} ( t ) = 0 ;$$

in addition,

$${A}_{ij}^{l} ( t ) = {I}_{ih}^{l} ( t ) {I}_{jh}^{l T} ( t ) ; {\hat{C}}^{l} ( t )$$

is a diagonal matrix whose nonzero term is the same as the diagonal element of I^{l}(t)^{T}I^{l}(t); and a weighted Laplacian matrix is calculated:

$$( 2 )$$

$${L}^{{H}_{l}} ( t ) = {D}^{l} ( t ) - {W}^{l} ( t ) , {D}^{l} ( t ) = diag ( {\sum }_{j = 1}^{N} {W}_{1 j}^{l} ( t ) , {\sum }_{j = 1}^{N} {W}_{2 j}^{l} ( t ) , … , {\sum }_{j = 1}^{N} {W}_{Nj}^{l} ( t ) )$$

The hyperedges are projected as a maximal clique by a weighted method and given different weights according to the hyperedge degree, and the time-varying hypergraph multi-agent grouping system is transformed into a weighted projection network. According to the definition of the weighted adjacent matrix, the high-order relationship within each group can be regarded as a weighted intra-group bilateral relation, i.e., hyperedge sets E₁(t) and E₂(t) can be written as (Φ₁(t), Π₁(t)) and (Φ₂(t), Π₂(t)), wherein Φₗ(t) represents a bilateral relation set, and Πₗ(t) represents a weight set. Therefore, the two groups of time-varying hypergraphs are converted into two weighted projection networks K₁(t)=(V₁, Φ₁(t), Π₁(t) and K₂(t)=(V₂Φ₂(t), Π₂(t) respectively.

An equivalent weighted projection model for the time-varying hypergraph multi-agent grouping system is established as follows:

$$( 3 )$$

$${\dot{x}}_{1 , i} = F ( {x}_{1 , i} ) + σ {\sum }_{h ; i ∈ {E}_{h}^{1} , j ∈ {E}_{h}^{1}} {\sum }_{j \neq i} ( {C}_{h h}^{1} ( t ) - 1 ) [ G ( {x}_{1 , j} ) - G ( {x}_{1 , i} ) ] + λ [ H ( {x}_{2 , i} ) - H ( {x}_{1 , i} ) ]$$

$${\dot{x}}_{2 , i} = F ( {x}_{2 , i} ) + σ {\sum }_{h ; i ∈ {E}_{h}^{2} , j ∈ {E}_{h}^{2}} {\sum }_{j \neq i} ( {C}_{h h}^{2} ( t ) - 1 ) [ G ( {x}_{2 , j} ) - G ( {x}_{2 , i} ) ] + λ [ H ( {x}_{1 , i} ) - H ( {x}_{2 , i} ) ]$$

$$That is ,$$

$$\begin{matrix}{\dot{x}}_{1 , i} = F ( {x}_{1 , i} ) + σ {\sum }_{h = 1}^{M} {\sum }_{j = 1}^{N} {I}_{ih}^{1} {I}_{jh}^{1} ( {C}_{hh}^{1} ( t ) - 1 ) [ G ( {x}_{1} , j ) - G ( {x}_{1 , i} ) ] + \\ λ [ H ( {x}_{2 , i} ) - H ( {x}_{1 , i} ) ] \\ = F ( {x}_{1 , i} ) + σ {\sum }_{j = 1}^{N} {W}_{ij}^{1} ( t ) [ G ( {x}_{1 , j} ) - G ( {x}_{1 , i} ) + λ [ H ( {x}_{2 , i} ) - H ( {x}_{1 , i} ) ] \\ = F ( {x}_{1 , i} ) + σ {\sum }_{j = 1}^{N} {L}_{ij}^{{H}_{1}} ( t ) [ G ( {x}_{1 , j} ) + λ [ H ( {x}_{2 , i} ) - H ( {x}_{1 , i} ) ]\end{matrix} \qquad ( 4 )$$

$$Similarly ,$$

$${\dot{x}}_{2 , i} = F ( {x}_{2 , i} ) - σ {\sum }_{j = 1}^{N} {L}_{ij}^{{H}_{2}} ( t ) G ( {x}_{2 , j} ) + λ [ H ( {x}_{1 , i} ) - H ( {x}_{2 , i} ) ]$$

wherein F:R^{d}→R^{d} represents a dynamical equation of the nodes, G:R^{d}×R^{d}→R^{d} and H:R^{d}×R^{d}→R^{d} are intra-group and inter-group linear coupling functions respectively, G(x)=Gx, and H(x)=Hx. σ and λ represent intra-group and inter-group coupling strength respectively;

$${C}_{hh}^{l} ( t )$$

represents the scale of the hyperedge

$${E}_{h}^{l} ; and {L}_{ij}^{{H}_{1}} and {L}_{ij}^{{H}_{2}}$$

are elements of weighted Laplacian matrixes of a first group and a second group respectively.

In a complex network, the dynamic behaviors of the nodes depend on three elements: dynamical equations, coupling modes and network topologies. In the model, it is assumed that the dynamics of a single node of each group is the same chaotic Rösler oscillator,

$$F ( {x}_{l , i} ) = ( \begin{matrix}- {y}_{l , i} - {z}_{l , i} \\ {x}_{l , i} + 0.2 {y}_{l , i} \\ 0.2 + {z}_{l , i} ( {x}_{l , i} - 5.7 )\end{matrix} ) \qquad ( 5 )$$

The two groups of time-varying hypergraphs use the same initial structure, and intra-group and inter-group coupling functions are G(x)=(0, y, 0)^{T} and H(x)=(0, y, 0)^{T} respectively.

Secondly, in order to represent the dynamic changes of the relationship between nodes and hyperedges of multiple agents, two variables are introduced to achieve the regulation of stochasticity of the time-varying hypergraph multi-agent grouping system. The first is the number of pairs of unequal stochastic elements exchanged simultaneously in the incidence matrix, IN. Each time the hypergraphs are switched, the incidence matrix thereof changes randomly according to the IN value. The second is the hypergraph switching frequency f, which represents the number of hypergraph switches per second. Therefore, the changes in the IN and f values mean changes in the stochasticity of the hypergraphs.

In order to measure the synchronizability of the time-varying hypergraph multi-agent grouping system, three aspects of intra-group synchronization errors, intra-group synchronization critical time and intra-group synchronization critical coupling strength are introduced to measure intra-group synchronizability. The improvement of stochasticity will lead to the improvement of synchronizability, which is represented in the decrease of the three indexes. The intra-group synchronization critical coupling strength refers to the intra-group synchronization critical coupling strength required for the time-varying hypergraphs to achieve intra-group synchronization and quantizes the coupling strength threshold required for the time-varying hypergraphs to achieve intra-group synchronization. The intra-group synchronization critical time represents the shortest time required to achieve synchronization among the nodes, and quantifies the speed of information transfer among the nodes. An intra-group synchronization error E is introduced:

$$E = {E}_{1} + {E}_{2} , {E}_{1} = \frac{1}{N} {\sum }_{i = 1}^{N} ‖ {x}_{1 , i} - {\overline{x}}_{1} ‖ , {E}_{2} = \frac{1}{N} {\sum }_{i = 1}^{N} ‖ {x}_{2} - {\overline{x}}_{2} ‖ \qquad ( 6 )$$

E₁ and E₂ represent intra-group synchronization errors of multiple agents of two groups of time-varying hypergraphs of the model respectively, and the threshold of the synchronization errors is set to 10⁻⁵.

In the hypergraphs, stochastic changes in the relationship between nodes and hyperedges mean changes in the high-order relationship, which is reflected in the exchange of unequal stochastic elements in the incidence matrix, and it is noted that the sum of rows of the incidence matrix represents the node hyperdegree and the sum of columns represents the hyperedge degree, which leads to changes in bilateral relations and weights in the weighted projection network accordingly. It is assumed herein that the exchange of elements in the incidence matrix follows the following rules:
Rule 1: each group of time-varying hypergraphs are switched at frequency f, and different pairs of stochastic elements in the incidence matrix are exchanged simultaneously at each switch, avoiding repeated selection of the same element.
Rule 2: each row and each column of the incidence matrix are not zero at any moment, ensuring that each node is in at least one hyperedge and each hyperedge comprises at least one node.
Rule 3: the dynamic changes of the incidence matrix are inheritable, and each change starts with a previous state.
Rule 4: when elements to be exchanged in the incidence matrix are selected, it is necessary to make sure that the exchange will not cause any column to become a logical subset of another column (that is, the element 1 of one column is contained in another column by position), otherwise it is necessary to re-select.

In order to better illustrate the time-varying mechanism introduced by the present invention, as shown in FIG. 2(b), the brown block of the incidence matrix represents randomized selection of unequal elements from columns E₁ and E₄ for exchange, and a node v₅ is switched from a hyperedge E₁ to a hyperedge E₄. The green block represents randomized selection of two different elements from the hyperedge E₄ for exchange, and nodes v₃ and v₄ of E₄ are changed to nodes v₄ and v₅. At this moment, IN=2, but the element 1 is contained in E₄ by position. To ensure that the time-varying hypergraphs are simple, stochastic elements shall be re-selected for exchange. The increase of the IN value means that the changes of the incidence matrix are more significant, the stochasticity of the model is enhanced, and the upper limit of IN is the number of non-zero elements of the incidence matrix. On the contrary, the decrease of the IN value means that the changes of the incidence matrix decrease, the stochasticity of the model is reduced, and the lower limit of IN is 0. On the other hand, the switching frequency f of the time-varying hypergraphs is the number of changes in the incidence matrix in unit time. The larger the IN and the switching frequency fare, the stronger the stochasticity of the time-varying hypergraph is.

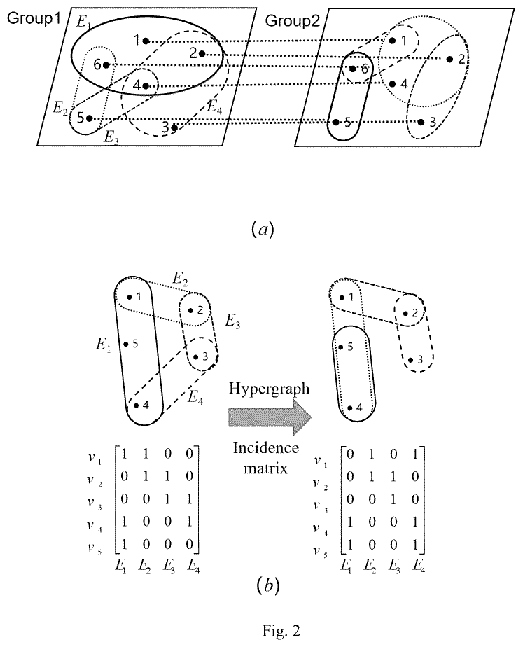

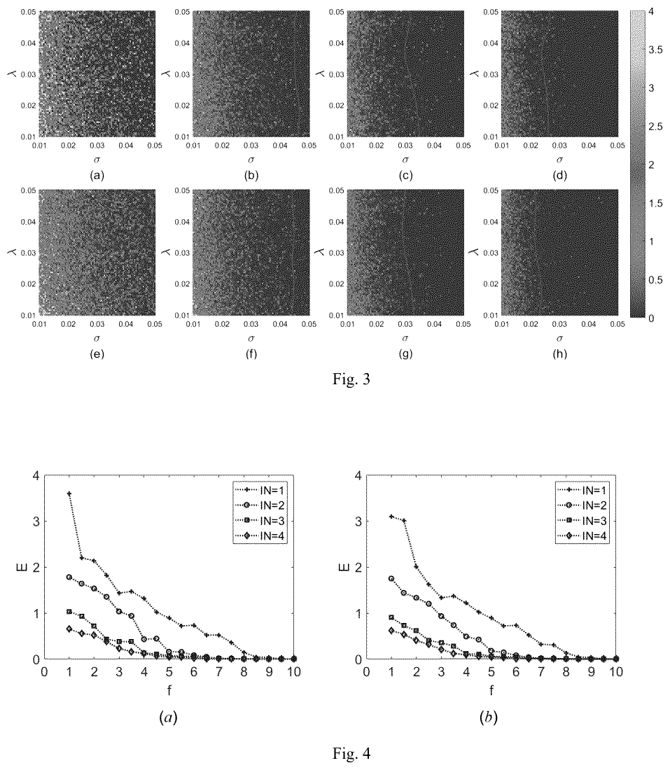

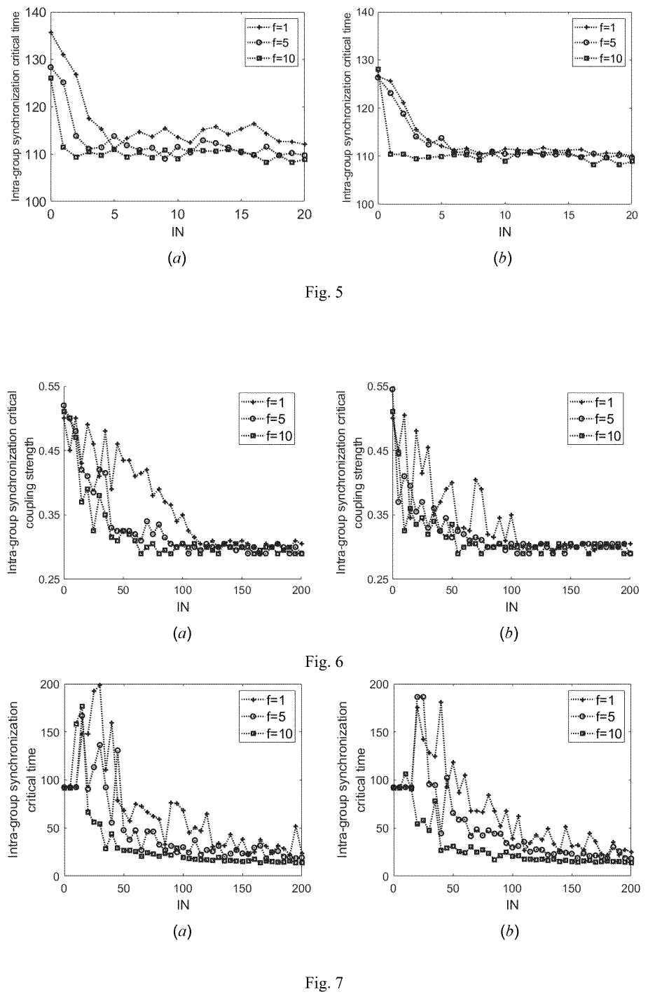

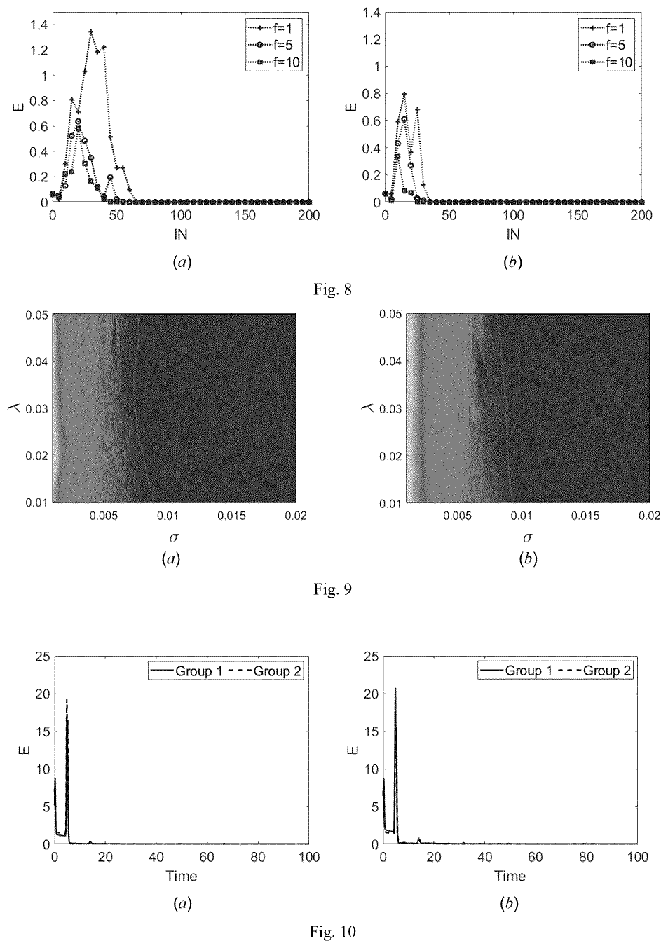

Assuming the evolution time T=200, the model (4) is numerically solved using the Runge Kutta-Fehlberg algorithm, with the integration step dt=0.01 and the integration time tspan=200, and stochastic initial values are taken for the equation at [0,1]. All the results are averaged over 10 experiments. Each experiment has two steps:
Step 1: setting the number of nodes of the model to N=20. FIG. 3 to FIG. 5 show the influence of the IN value on the intra-group synchronization critical coupling strength and the synchronization region, the influence of stochasticity of the time-varying hypergraphs on the intra-group synchronization errors and the influence of stochasticity of the time-varying hypergraphs on the intra-group synchronization critical time respectively. As shown in FIG. 3, when IN is 1, 2, 3 or 4, it is found through horizontal comparison that the larger the IN value is, the synchronization region of the time-varying hypergraphs is. It is found through vertical comparison that the synchronization region of multi-agent grouping systems of two groups of time-varying hypergraphs under the condition of independent stochastic variation is slightly larger than that of the two groups under the condition of simultaneous variation, which indicates that the critical curve moves closer to the left with the increase of IN. Given the value of the inter-group coupling strength λ, the value of the critical coupling strength σ required for the model to achieve intra-group synchronization gradually decreases with the increase of IN. FIG. 4 shows that when the frequency f is fixed, the intra-group synchronization critical time decreases rapidly with the increase of IN. Meanwhile, as the frequency f gradually increases, the curve decreases as a whole, indicating that the stronger the stochasticity of the hypergraphs is, the shorter the intra-group synchronization critical time of the model (4) is. No significant difference is found in the intra-group synchronization critical time under the conditions of independent stochastic evolution and consistent stochastic evolution of multiple agents of the two groups of time-varying hypergraphs. FIG. 5 shows intra-group synchronization error-switching frequency curves (E-f curves) under the conditions of consistent stochastic variation and independent stochastic variation of multiple agents of the two groups of time-varying hypergraphs. The frequency f is inversely proportional to the intra-group synchronization errors, and the E-f curve decreases as a whole with the increase of IN. When IN=1, the curve E is 0 approximately at f=9, and the time-varying hypergraphs achieve intra-group synchronization. When IN=2, 3 or 4, the frequency is f=7 so that the time-varying hypergraphs achieve intra-group synchronization. In addition, it is found through horizontal comparison of FIG. 5 that when IN is fixed, the value of the intra-group synchronization error under the condition of independent stochastic variation is lower than that under the condition of consistent stochastic variation on the whole. In order to enable the time-varying hypergraphs to achieve intra-group synchronization even when the stochasticity is the weakest, the intra-group coupling strength σ is set to 0.2, and the inter-group coupling strength λ is maintained to 0.01.
Step 2: setting the number of nodes of the model to N=200. FIG. 6 to FIG. 8 show the influence of the IN value on the intra-group synchronization critical coupling strength and the synchronization region, the influence of stochasticity of the time-varying hypergraphs on the intra-group synchronization errors and the influence of stochasticity of the time-varying hypergraphs on the intra-group synchronization critical time respectively. FIG. 6 shows that the intra-group synchronization critical coupling strength decreases fluctuatingly with the increase of IN and stabilizes around 0.1 after IN is sufficiently large, and the larger the switching frequency f is, the lower the curve is, and the earlier the curve tends to stabilize. It can be found through data comparison that the intra-group synchronization critical coupling strength of multiple agents of the two groups of time-varying hypergraphs under the condition of independent stochastic variation is slightly lower than that under the condition of consistent stochastic variation. FIG. 7 shows the trend of inversely proportional change of the intra-group synchronization critical time and the stochasticity of the hypergraphs. Intuitively, the intra-group synchronization critical time increases within a short period where IN begins to increase, but when IN continues to increase, the intra-group synchronization critical time decreases rapidly and stabilizes around 20. Moreover, the larger the f value is, the lower the curve is, the less the curve fluctuates, and the earlier the evolution of the intra-group synchronization critical time tends to stabilize. No significant difference is found in the intra-group synchronization critical time under the conditions of independent stochastic variation and consistent stochastic variation of multiple agents of the two groups of time-varying hypergraphs. As shown in FIG. 8, at the initial stage when IN gradually increases, the intra-group synchronization error increases rapidly to a peak, then decreases rapidly after IN continues to increase, and finally stabilizes at 0. When f increases, the curve of the intra-group synchronization errors decreases as a whole. In addition, it is found through horizontal comparison that under the condition that the frequencies f are the same, the intra-group synchronization errors of multiple agents of the two groups of time-varying hypergraphs under the condition of independent stochastic evolution is smaller than that under the condition of consistent stochastic evolution, and the former requires a smaller IN value to achieve intra-group synchronization. For example, when f=1, and IN=112 under the condition of independent evolution, the intra-group synchronization error is less than 10⁻⁵; and the same effect can be achieved only when IN=130 under the condition of simultaneous evolution. Arrows in different colors point to start points with the intra-group synchronization errors less than 10⁻⁵ corresponding to different frequencies.

Thirdly, when the long term intra-group synchronization behaviors of (4) are studied, in order to reduce the complexity of time-varying hypergraphs and preserve the global features of the time-varying hypergraphs, it is assumed that the time-varying hypergraphs have the characteristics of fast switching. Lemma 1 states that if the system is switched fast enough, the switching system will approximate a time-averaged system. Then a time-varying model is transformed into a static model and subjected to linear stability analysis and global stability analysis to obtain an implicit expression of an intra-group synchronization region and a coupling strength threshold of global intra-group synchronization. According to the results obtained by Stilwell et al. in the article “Sufficient conditions for fast switching synchronization in temporal network topologies”, conclusions are made as follows:

Lemma 1: assuming a sufficiently large constant T, if

$$\frac{1}{T} {\int }_{t}^{t + T} \prod ( τ ) d τ = \overline{\prod }$$

for any time t and a matrix-valued function Π(t), and the system

$$\dot{x} ( t ) = [ A ( t ) + \overline{\prod } ] x ( t ) , x ( {t}_{0} ) = {x}_{0} , t \geq {t}_{0}$$

is uniformly exponentially stable, a fast switching system

$$\dot{z} ( t ) = [ A ( t ) + \prod ( t ) ] z ( t ) , z ( {t}_{0} ) = {z}_{0} , t \geq {t}_{0}$$

is also uniformly exponentially stable.

According to lemma 1, for the sufficiently large constant T, equation (4) has the same stability as the following time-average equation under the condition of hypergraph fast switching.

$${X}_{1} = {⊕}_{i = 1}^{N} F ( {x}_{1 , i} ) - σ {\overline{L}}^{{H}_{1}} ⊗ {GX}_{1} + λ {⊕}_{i = 1}^{N} ( {Hx}_{2 , i} - {Hx}_{1 , i} ) \\ {X}_{2} = {⊕}_{i = 1}^{N} F ( {x}_{2 , i} ) - σ {\overline{L}}^{{H}_{2}} ⊗ {GX}_{2} + λ {⊕}_{i = 1}^{N} ( {Hx}_{1 , i} - {Hx}_{2 , i} ) \\ wherein \\ \frac{1}{T} {\int }_{t}^{t + T} {L}^{{H}_{1}} ( τ ) d τ = {\overline{L}}^{{H}_{1}} and \frac{1}{T} {\int }_{t}^{t + T} {L}^{{H}_{2}} ( τ ) d τ = {\overline{L}}^{{H}_{2}} . \qquad ( 7 )$$

The equation is decoupled:

$${\dot{x}}_{1 , i} = F ( {x}_{1 , i} ) - σ {\sum }_{j = 1}^{N} {\overline{L}}_{ij}^{{H}_{1}} G ( {x}_{1 , j} ) + λ [ H ( {x}_{2 , i} ) - H ( {x}_{1 , i} ) ] \\ {\dot{x}}_{2 , i} = F ( {x}_{2 , i} ) - σ {\sum }_{j = 1}^{N} {\overline{L}}_{ij}^{{H}_{2}} G ( {x}_{2 , j} ) + λ [ H ( {x}_{1 , i} ) - H ( {x}_{2 , i} ) ] \qquad ( 8 )$$

Next, stability analysis is carried out, comprising two parts: linear stability analysis and global stability analysis. The linear stability analysis comprises the following steps:
Step 1: letting x_{1,S} and x_{2,S} represent synchronization state variables of the first group and the second group respectively, and studying dynamical equations of perturbation vectors δx_{1,i}=x_{1,i}−x_{1,S} and δx_{2,i}=x_{2,i}−x_{2,S}, thereby obtaining a linearized equation from formula (8):

$$δ {\dot{x}}_{1 , i} = JF ( {x}_{1 , S} ) δ {x}_{1 , i} - σ {\sum }_{j = 1}^{N} {\overline{L}}_{ij}^{{H}_{1}} JG ( {x}_{1 , S} ) δ {x}_{1 , j} + λ [ JH ( {x}_{2 , S} ) δ {x}_{2 , i} - JH ( {x}_{1 , S} ) δ {x}_{1 , i} ] \\ δ {\dot{x}}_{2 , i} = JF ( {x}_{2 , S} ) δ {x}_{1 , i} - σ {\sum }_{j = 1}^{N} {\overline{L}}_{ij}^{{H}_{2}} JG ( {x}_{2 , S} ) δ {x}_{2 , j} + λ [ JH ( {x}_{1 , S} ) δ {x}_{1 , i} - JH ( {x}_{2 , S} ) δ {x}_{2 , i} ] \qquad ( 9 )$$

J is a Jacobi operator.

$$δ {x}_{1} = {[ δ {x}_{1 , 1}^{T} , δ {x}_{1 , 2}^{T} , … , δ {x}_{1 , N}^{T} ]}^{T} and δ {x}_{2} = {[ δ {x}_{2 , 1}^{T} , δ {x}_{2 , 2}^{T} , … , δ {x}_{2 , N}^{T} ]}^{T}$$

are introduced, and the linearized equation (9) is rewritten in a tensor form:

$$δ {\dot{x}}_{1} = [ {I}_{N} ⊗ JF ( {x}_{1 , S} ) - σ {\overline{L}}^{{H}_{1}} ⊗ JG ] δ {x}_{1} + λ [ {I}_{N} ⊗ JH ( {x}_{2 , S} ) δ {x}_{2} - {I}_{N} ⊗ JH ( {x}_{1 , S} ) δ {x}_{1} ] \\ δ {\dot{x}}_{2} = [ {I}_{N} ⊗ JF ( {x}_{2 , S} ) - σ {\overline{L}}^{{H}_{2}} ⊗ JG ] δ {x}_{2} + λ [ {I}_{N} ⊗ JH ( {x}_{1 , S} ) δ {x}_{1} - {I}_{N} ⊗ JH ( {x}_{2 , S} ) δ {x}_{2} ] \qquad ( 10 )$$

Step 2: diagonalizing L̅^{H}^{₁} and L̅^{H}^{₂}, if interchangeable, under the same basis, which means that a group of eigenvectors are shared, and denoting as V=[v₁, v₂, . . . , v_{N}], then

$${Λ}_{1} = {V}^{- 1} {\overline{L}}^{{H}_{1}} V = diag \{ 0 = {γ}_{1} \leq {γ}_{2} \leq … \leq {γ}_{N} \} \\ {Λ}_{2} = {V}^{- 1} {\overline{L}}^{{H}_{2}} V = diag \{ 0 = {ρ}_{1} \leq {ρ}_{2} \leq … \leq {ρ}_{N} \}$$

δxₗ is projected on V and denoted as ξ^{(l)}=(V⁻¹⊗I_{d})δxₗ, and a variation equation (10) is converted to:

$${\dot{ξ}}^{( 1 )} = [ {I}_{N} ⊗ JF ( {x}_{1 , S} ) - σ {Λ}_{1} ⊗ JG ] {ξ}^{( 1 )} + λ [ {I}_{N} ⊗ JH ( {x}_{2 , S} ) {ξ}^{( 2 )} - {I}_{N} ⊗ JH ( {x}_{1 , S} ) {ξ}^{( 1 )} ] \\ {ξ}^{( 2 )} = [ {I}_{N} ⊗ JF ( {x}_{2 , S} ) - σ {Λ}_{2} ⊗ JG ] {ξ}^{( 2 )} + λ [ {I}_{N} ⊗ JH ( {x}_{1 , S} ) {ξ}^{( 1 )} - {I}_{N} ⊗ JH ( {x}_{2 , S} ) {ξ}^{( 2 )} ] \qquad ( 11 )$$

which is written in a component form to obtain a master stabilizing equation:

$${\dot{ξ}}_{i}^{( 1 )} = JF ( {x}_{1 , S} ) {ξ}_{i}^{( 1 )} - σ {γ}_{i} JG {ξ}_{i}^{( 1 )} + λ [ JH ( {x}_{2 , S} ) {ξ}_{i}^{( 2 )} - JH ( {x}_{1 , S} ) {ξ}_{i}^{( 1 )} ] \\ {ξ}_{i}^{( 2 )} = JF ( {x}_{2 S} ) {ξ}_{i}^{( 2 )} - σ {ρ}_{i} JG {ξ}_{i}^{( 2 )} + λ [ JH ( {x}_{1 , S} ) {ξ}_{i}^{( 1 )} - JH ( {x}_{2 , S} ) {ξ}_{i}^{( 2 )} ] \qquad ( 12 )$$

$${ξ}_{1}^{( l )}$$

represents motion along intra-group synchronization manifold, and other

$${ξ}_{i}^{( l )}$$

represents evolution of different modes intersecting synchonization manifold.
Step 3: through the master stabilizing equation (12) and an equation satisfied by a nonlinear synchronization solution (x_{1,S}, x_{2,S}):

$${\dot{x}}_{1 , S} = F ( {x}_{1 , S} ) + λ [ H ( {x}_{2 , S} ) - H ( {x}_{1 , S} ) ] \\ {\dot{x}}_{2 , S} = F ( {x}_{2 , S} ) + λ [ H ( {x}_{1 , S} ) - H ( {x}_{2 , S} ) ] \qquad ( 13 )$$

calculating largest transverse Lyapunov exponents:

$${Ω}_{1} ( σ , λ , {Λ}_{1} ) = {〈 {lim}_{t \to 0} \frac{1}{t} ln \vert {ξ}_{i}^{( 1 )} {ξ}_{i}^{( 1 )} ( 0 ) \vert 〉}_{m ax}^{1} \\ {Ω}_{2} ( σ , λ , {Λ}_{2} ) = {〈 {lim}_{t \to 0} \frac{1}{t} ln \vert {ξ}_{i}^{( 2 )} {ξ}_{i}^{( 2 )} ( 0 ) \vert 〉}_{ma x}^{2} \qquad ( 14 )$$

so as to determine synchronization manifold stability regions of the time-averaged approximate equation (8), wherein

$${ξ}_{i}^{( 1 )} ( 0 ) and {ξ}_{i}^{( 2 )} ( 0 )$$

represent initial values of equation (8), and [symbol] [symbol] ₘₐₓ represents the maximum value obtained when i traverses all the nodes in the group; and Ω₁, and Ω₂ are the largest transverse Lyapunov exponents of multiple agents of the two groups of time-varying hypergraphs. The necessary conditions for equation (8) to achieve linear stability are Ω₁<0 and Ω₂<0; when the inter-group coupling strength λ is constant, the intra-group synchronization critical coupling strength is obtained according to Ω₁=0 and Ω₂=0; the time when the system achieves intra-group synchronization errors less than the threshold value 10⁻⁵ for the first time is recorded as the intra-group synchronization critical time, and the value thereof can be given by numerical simulation according to formula (6); and intra-group synchronization regions are represented respectively as follows:

$${R}_{1} = \{ ( {α}_{1} , {β}_{1} ) : {Ω}_{1} < 0 \} \\ {R}_{2} = \{ ( {α}_{2} , {β}_{2} ) : {Ω}_{2} < 0 \} \qquad ( 15 )$$

The switching frequency is f=50, and the evolution time of the model is T=50000. Equation (8) is numerically integrated using the Runge Kutta-Fehlberg algorithm, with the integration step dt=0.01, and stochastic initial values are taken for the equation at [0,1]. FIG. 9(a) is a heat map of intra-group synchronization errors of long term evolution fast switching hypergraphs at the number of nodes N=20. It can be seen that the synchronization region of the time-averaged approximate equations is larger. The curve in the figure shows that the largest Lyapunov exponent is 0. In addition, the coupling strength σ=0.2 and λ=0.01 are fixed, and the intra-group synchronization critical time of the time-averaged approximate equations is t=6.983, which is much lower than the value corresponding to short term evolution.

FIG. 9(b) is a heat map of intra-group synchronization errors of long term evolution fast switching hypergraphs at the number of nodes N=200. It can be seen that the value of intra-group synchronization critical coupling strength is much less than 0.1. In addition, the coupling strength is fixed to σ=0.4 and λ=0.01, the intra-group synchronization critical time is calculated to obtain t=16.026, which is lower than the stable value in FIG. 8. To sum up, the synchronizability of the time-averaged approximate equation (8) is better than that of time-varying equations (3)-(4), i.e., the synchronizability of the model under the condition of long term fast switching is better than that under the condition of short term evolution.

The global stability analysis comprises the following steps:
Step 1: according to equations (8) and (11), obtaining an error equation:

$$\{ \begin{matrix}δ {\dot{x}}_{1 , i} = F ( {x}_{1 , i} ) - F ( {x}_{1 , S} ) - σ {\sum }_{j = 1}^{N} {\overline{L}}_{ij}^{{H}_{1}} G ( δ {x}_{1 , j} ) + λ H ( δ {x}_{2 , i} - δ {x}_{1 , i} ) \\ δ {\dot{x}}_{2 , i} = F ( {x}_{2 , i} ) - F ( {x}_{2 , S} ) - σ {\sum }_{j = 1}^{N} {\overline{L}}_{ij}^{{H}_{2}} G ( δ {x}_{2 , j} ) + λ H ( δ {x}_{1 , i} - δ {x}_{2 , i} )\end{matrix} \qquad ( 16 )$$

A Lyapunov function is constructed: Y(t)=Y₁(t)+Y₂(t), wherein

$${Y}_{1} ( t ) = \frac{1}{2} {\sum }_{i = 1}^{N} {( δ {x}_{1 , i} )}^{T} δ {x}_{1 , i} , {Y}_{2} ( t ) = \frac{1}{2} {\sum }_{i = 1}^{N} {( δ {x}_{2 , i} )}^{T} δ {x}_{2 , i} \qquad ( 17 )$$

Step 2: giving some necessary assumptions and lemmas before analyzing the symbols of the Lyapunov function:
Assumption 1: F(·) satisfies the Lipschitz condition that a positive constant M exists so that ∥F(x)−F(y)∥≤M∥x−y∥, wherein ∥·∥ is a Euclidean norm.
Lemma 1: assuming that e₁, . . . , eₖ and r₁, . . . , rₗ are eigenvectors of matrixes A and B respectively, the eigenvector of A⊗B is eᵢ×rⱼ(1≤i≤k, 1≤j≤l ), wherein ⊗ represents a knocker product.
Theorem 1: Assuming that G is a positive definite matrix, while His a symmetric matrix. If the node dynamics F(·) satisfies assumption 1, then the coupling strength

$${σ}_{0} = \frac{1}{{\partial }_{2} ( Λ ⊗ G )} ( M + λ {\partial }_{ma x} ( ( {V}^{- 1} Q V ) ⊗ H ) )$$

exists, and when σ>σ₀, the time-varying hypergraph multi-agent grouping system achieves global intra-group synchronization.
Proof: using assumption 1, it is obtained that

$$\begin{matrix}{\dot{Y}}_{1} ( t ) = {\sum }_{i = 1}^{N} {( δ {x}_{1 , i} )}^{T} \dot{δ} {x}_{1 , i} \\ = {\sum }_{i = 1}^{N} {( δ {x}_{1 , i} )}^{T} [ F ( {x}_{1 , i} ) - F ( {x}_{1 , S} ) - σ {\sum }_{j = 1}^{N} {\overline{L}}_{ij}^{{H}_{1}} G δ {x}_{1 , i} - \\ λH ( δ {x}_{1 , i} - δ {x}_{2 , i} ) ] \\ \leq {\sum }_{1}^{N} {M ( δ {x}_{1 , i} )}^{T} δ {x}_{1 , i} - σ {\sum }_{i = 1}^{N} {\sum }_{j = 1}^{N} {{\overline{L}}_{ij}^{{H}_{1}} ( δ {x}_{1 , i} )}^{T} G δ {x}_{1 , i} - \\ λ {\sum }_{i = 1}^{N} {( δ {x}_{1 , i} )}^{T} H δ {x}_{1 , i} + λ {\sum }_{i = 1}^{N} {( δ {x}_{1 , i} )}^{T} H δ {x}_{2 , i}\end{matrix} \qquad ( 18 )$$

$$Similarly ,$$

$${\dot{Y}}_{2} ( t ) \leq {\sum }_{i = 1}^{N} {M ( δ {x}_{2 , i} )}^{T} δ {x}_{2 , i} - σ {\sum }_{i = 1}^{N} {\sum }_{j = 1}^{N} {{L}_{ij}^{{H}_{2}} ( δ {x}_{2 , i} )}^{T} G δ {x}_{2 , i} - λ {\sum }_{i = 1}^{N} {( δ {x}_{2 , i} )}^{T} H δ {x}_{2 , i} + λ {\sum }_{i = 1}^{N} {( δ {x}_{2 , i} )}^{T} H δ {x}_{1 , i} \qquad ( 19 )$$

$$\overline{L} = ( \begin{matrix}{\overline{L}}^{{H}_{1}} & 0 \\ 0 & {\overline{L}}^{{H}_{2}}\end{matrix} ) ∈ {R}^{2 N \times 2 N} , Q = ( \begin{matrix}- {I}_{N} & {I}_{N} \\ {I}_{N} & - {I}_{N}\end{matrix} ) and$$

$$δ x = [ {( δ {x}_{1} )}^{T} , {( δ {x}_{2} )}^{T} ] ∈ {R}^{2 d N} , and {I}_{N} , {I}_{2 N}$$

and I_{2dN} represent unit matrixes of N×N, 2N×2N and 2dN×2dN respectively; and through calculation,

$$\begin{matrix}\dot{Y} ( t ) \leq M {( δ x )}^{T} δ x - {σ ( δ x )}^{T} ( \overline{L} ⊗ G ) δ x - d {( δ x )}^{T} ( {I}_{2 N} ⊗ H ) δ x + \\ {λ ( δ x )}^{T} [ ( {I}_{2 N} ( \begin{matrix}0 & {I}_{N} \\ {I}_{N} & 0\end{matrix} ) ) ⊗ H ] δ x \\ = {( δ x )}^{T} [ {MI}_{2 dN} - σ ( \overline{L} ⊗ G ) + λ ( Q ⊗ H ) ] δ x\end{matrix} \qquad ( 20 )$$

It is noted that a matrix v exists so that Λ=V⁻¹L̅V, wherein Λ is a diagonal matrix composed of

$${γ}_{i} and {ρ}_{i} , 0 = {γ}_{1} \leq {γ}_{2} \leq … \leq {γ}_{N} , and 0 = {ρ}_{1} \leq {ρ}_{2} \leq … \leq {ρ}_{N} . \\ ξ = ( {V}^{- 1} ⊗ {I}_{d} ) δ x = {( {ξ}_{1}^{T} , {ξ}_{2}^{T} , … , {ξ}_{2 N}^{T} )}^{T} ,$$

wherein ξᵢ is a d-dimensional vector.

$$σ = {σ}_{0} + 1 = \frac{1}{{\partial }_{2} ( Λ ⊗ G )} ( M + λ {\partial }_{ma x} ( ( {V}^{- 1} Q V ) ⊗ H ) ) + 1 ,$$

and it is obtained through calculation that

$$\begin{matrix}\dot{Y} ( t ) \leq M {ξ}^{T} ξ - σ {ξ}^{T} ( Λ ⊗ G ) ξ + λ {ξ}^{T} ( ( {V}^{- 1} QV ) ⊗ H ) ξ \leq \\ ( L - σ {\partial }_{2} ( Λ ⊗ G ) + λ {\partial }_{ma x} ( ( {V}^{- 1} QV ) ⊗ H ) ) {ξ}^{T} ξ \\ = - {\partial }_{2} ( Λ ⊗ G ) {ξ}^{T} ξ = - {\partial }_{2} ( Λ ⊗ G ) {( δ x )}^{T} δ x\end{matrix} \qquad ( 21 )$$

wherein ∂₂(Λ⊗G) represents the second minimum eigenvalue of Λ⊗G, and ∂ₘₐₓ((V⁻¹ [symbol] V)⊗H) represents the largest eigenvalue of (V⁻¹ [symbol] V)⊗H. Theorem 1 is proved according to the LaSalle's invariance principle.
Inference 1: if an intra-group coupling matrix is G=diag(1, 1, 1), and the inter-group coupling matrix H is positive semidefinite, when

$$σ > {\tilde{σ}}_{0} ▯ \frac{M}{min \{ {γ}_{2} , {ρ}_{2} \}}$$

the system (8) achieves intra-group synchronization.
Proof: it is noted that V⁻¹ [symbol] V has the same eigenvalues 0 and −2 as Q. According to lemma 1,

$${\partial }_{2} ( Λ ⊗ G ) = {\partial }_{2} ( Λ ) {\partial }_{m i n} ( G ) = min ( {γ}_{2} , {ρ}_{2} ) , so \\ \dot{V} ( t ) \leq min ( {γ}_{2} , {ρ}_{2} ) ( {\tilde{σ}}_{0} - σ ) {ξ}^{T} ξ = min ( {γ}_{2} , {ρ}_{2} ) ( {\tilde{σ}}_{0} - σ ) δ {x}^{T} δ x < 0.$$

Step 3: if intra-group coupling is vector coupling, the intra-group coupling matrix is G=diag(1, 1, 1), and it is estimated that the Lipschitz constant M of the oscillator dynamics equation (5) is about 22.2. For N=20, min (γ₂, ρ₂)=21.5195, so \tilde{σ}₀≈1.03.

Simulation parameters are set to be consistent with those in FIG. 9, and stochastic initial values are taken for the equation at [0, 15]. FIG. 10(a) is a time series graph of intra-group synchronization errors of a time-averaged network at N=20, and when the coupling strength is set to σ=1.1, the system achieves intra-group synchronization respectively at t=12.14 and t=12.89. Similarly, for N=200, min (γ₂,ρ₂)=19.0258, so \tilde{δ}₀≈1.17. FIG. 10(b) is a time series graph of intra-group errors of the time-averaged network at N=200, and when the coupling strength is set to σ=1.2, the system achieves intra-group synchronization respectively at t=39.92 and t=40.78. The experiments show that when the coupling strength of an oscillator system reaches more than \tilde{σ}₀, the initial states of equation (8) are quite different, but the oscillator system can still achieve intra-group synchronization after a period of time.

The above-mentioned technical solution only reflects a preferred technical solution of technical solutions of the present invention. Some changes made to certain parts by those skilled in the art all reflect the principle of the present invention, and belong to the protective scope of the present invention.

1. A synchronous enhancement method for time-varying hypergraph multi-agent grouping systems based on randomized topology switching, comprising the following steps:
step 1: constructing an equivalent model for a time-varying hypergraph multi-agent grouping system using a weighted projection method;
a time-varying hypergraph multi-agent grouping system composed of N nodes is divided to form two subsets which have the same number of nodes and never join, each subset is regarded as a group, intra-group and inter-group connections of multiple agents are constructed one to one in a high-order relationship respectively, and each group corresponds to one hypergraph, wherein Nis even; assuming that one hypergraph has K hyperedges and N/2 nodes, the dependencies of the nodes and the hyperedges evolve over time; the hyperedges are projected as a maximal clique by a weighted method and given different weights according to the hyperedge degree, and the hypergraph is transformed into a weighted projection network; and an equivalent weighted projection model for the time-varying hypergraph multi-agent grouping system is established as follows:
$${\dot{x}}_{1 , i} = F ( {x}_{1 , i} ) + σ {\sum }_{h : i ∈ {E}_{h}^{1} , j ∈ {E}_{h}^{1}} {\sum }_{j \neq i} ( {C}_{hh}^{1} ( t ) - 1 ) [ G ( {x}_{1 , j} ) - G ( {x}_{1 , i} ) ] + λ [ H ( {x}_{2 , i} ) - H ( {x}_{1 , i} ) ] \\ {\dot{x}}_{2 , i} = F ( {x}_{2 , i} ) + σ {\sum }_{h : i ∈ {E}_{h}^{2} , j ∈ {E}_{h}^{2}} {\sum }_{j \neq i} ( {C}_{hh}^{2} ( t ) - 1 ) [ G ( {x}_{2 , j} ) - G ( {x}_{2 , i} ) ] + λ [ H ( {x}_{1 , i} ) - H ( {x}_{2 , i} ) ] \qquad ( 1 )$$
$$that is ,$$
$${\dot{x}}_{1 , i} = F ( {x}_{1 , i} ) - σ {\sum }_{j = 1}^{N} {L}_{ij}^{{H}_{1}} ( t ) G ( {x}_{1 , j} ) + λ [ H ( {x}_{2 , i} ) - H ( {x}_{1 , i} ) ] \\ {\dot{x}}_{2 , i} = F ( {x}_{2 , i} ) - σ {\sum }_{j = 1}^{N} {L}_{ij}^{{H}_{2}} ( t ) G ( {x}_{2 , j} ) + λ [ H ( {x}_{1 , i} ) - H ( {x}_{2 , i} ) ] \qquad ( 2 )$$
wherein F:R^{d}→R^{d} represents a dynamical equation of the nodes, G:R^{d}×R^{d}→R^{d} represents an intra-group linear coupling function, H:R^{d}×R^{d}→R^{d} represents an inter-group linear coupling function, G(x)=Gx, H(x)=Hx, σ represents intra-group coupling strength, and λ represents inter-group coupling strength; x_{l,i} represents an i^{th} agent in an l^{th} group, wherein j is another agent in the same group as i;
$${C}_{hh}^{l} ( t )$$
represents the scale or an h^{th} hyperedge
$${E}_{h}^{l}$$
in the l^{th} group, with the value changing over time, wherein l=1 or 2; t represents a time variable; and
$${L}_{ij}^{{H}_{1}} ( t )$$
is an element of a weighted Laplacian matrix of a first group, and
$${L}_{ij}^{{H}_{2}} ( t )$$
is an element of a weighted Laplacian matrix of a second group, wherein the weighted Laplacian matrix is defined as follows:
$${L}^{{H}_{l}} ( t ) = {D}^{l} ( t ) - {W}^{l} ( t ) \qquad ( 3 )$$
wherein
$${D}^{l} ( t ) = diag ( {\sum }_{j = 1}^{N} {W}_{1 j}^{l} ( t ) , {\sum }_{j = 1}^{N} {W}_{2 j}^{l} ( t ) , … , {\sum }_{j = 1}^{N} {W}_{Nj}^{l} ( t ) ) ;$$
and an element
$${W}_{ij}^{l} ( t )$$
of a weighted adjacent matrix W^{l}(t) is defined as follows:
$${W}_{ij}^{l} ( t ) = \{ \begin{matrix}{\sum }_{h} ( {C}_{hh}^{l} ( t ) - 1 ) {I}_{ih}^{l} ( t ) {I}_{jh}^{l} ( t ) = {( {I}^{l} ( t ) {\hat{C}}^{l} ( t ) {{I}^{l} ( t )}^{T} )}_{ij} - {A}_{ij}^{l} ( t ) , & i \neq j \\ 0 , & i = j\end{matrix} \qquad ( 4 )$$
wherein I^{l}(t) is an incidence matrix of the l^{th} group, and a matrix element is
$${I}_{ih}^{l} ( t ) ;$$
when the node i of the l^{th} group belongs to the hyperedge
$${E}_{h}^{l} , {I}_{ih}^{l} ( t ) = 1 , otherwise {I}_{h}^{l} ( t ) = 0 ; {A}_{ij}^{l} ( t ) = {I}_{ih}^{l} ( t ) {{I}_{jh}^{l}}^{T} ( t ) ;$$
and Ĉ^{l}(t) is a diagonal matrix whose nonzero term is the same as the diagonal element of I^{l}(t)^{T}I^{l}(t);
step 2: setting evolution rules, stochasticity measurement indexes and intra-group synchronizability measurement indexes, and designing evolution rules of the hypergraph multi-agent grouping system;
(1) stochasticity measurement indexes of evolution rules: the regulation of stochasticity of the time-varying hypergraph multi-agent grouping system is achieved by introducing two variables: the first is the number of pairs of unequal stochastic elements exchanged simultaneously in the incidence matrix, and the second is the hypergraph switching frequency f, each time the hypergraphs are switched, the incidence matrix thereof changes randomly according to the IN value; and the changes in the IN and f values mean changes in the stochasticity of the hypergraphs;
(2) intra-group synchronizability measurement indexes: intra-group synchronizability is measured from three aspects: intra-group synchronization errors, intra-group synchronization critical time and intra-group synchronization critical coupling strength; the improvement of the intra-group synchronizability is represented in the decrease of the three indexes; and an intra-group synchronization error E is introduced:
$$E = {E}_{1} + {E}_{2} , {E}_{1} = \frac{1}{N} {\sum }_{i = 1}^{N} ‖ {x}_{1 , i} - {\overline{x}}_{1} ‖ , {E}_{2} = \frac{1}{N} {\sum }_{i = 1}^{N} ‖ {x}_{2 , i} - {\overline{x}}_{2} ‖ \qquad ( 5 )$$
wherein E₁ and E₂ represent synchronization errors of two groups of time-varying hypergraphs respectively, and the threshold of the synchronization errors is set to 10⁻⁵;
(3) design of evolution rules of the hypergraph multi-agent grouping system:
rule 1: each group of hypergraphs are switched at frequency f, and different pairs of stochastic elements in the incidence matrix are exchanged simultaneously at each switch, avoiding repeated selection of the same element;
rule 2: each row and each column of the incidence matrix are not zero at any moment, ensuring that each node is in at least one hyperedge and each hyperedge comprises at least one node;
rule 3: the dynamic changes of the incidence matrix are inheritable, and each change starts with a previous state;
rule 4: when elements to be exchanged in the incidence matrix are selected, it is necessary to make sure that the exchange will not cause any column to become a logical subset of another column, otherwise it is necessary to re-select;
step 3: under the conditions of long term evolution and hypergraph fast switching, obtaining time-averaged approximate equations according to the equivalent weighted projection model; analyzing necessary conditions for the linear stability of the time-averaged approximate equations using a master stabilizing function method; and by constructing an error equation and a Lyapunov function to judge the global stability of the time-averaged approximate equations, establishing global synchronization criteria;
step 3.1: letting
$$\frac{1}{T} {\int }_{t}^{t + T} {L}^{{H}_{1}} ( τ ) d τ = {\overline{L}}^{{H}_{1}} and \frac{1}{T} {\int }_{t}^{t + T} {L}^{{H}_{2}} ( τ ) d τ = {\overline{L}}^{{H}_{2}} ,$$
processing the equivalent weighted projection model using the time-averaged approximate equations to obtain a time approximate equation:
$${\dot{x}}_{1 , i} = F ( {x}_{1 , i} ) - σ {\sum }_{j = 1}^{N} {\overline{L}}_{ij}^{{H}_{1}} G ( {x}_{1 , j} ) + λ [ H ( {x}_{2 , i} ) - H ( {x}_{1 , i} ) ] \qquad ( 6 )$$
$${\dot{x}}_{2 , i} = F ( {x}_{2 , i} ) - σ {\sum }_{j = 1}^{N} {\overline{L}}_{ij}^{{H}_{2}} G ( {x}_{2 , j} ) + λ [ H ( {x}_{1 , i} ) - H ( {x}_{2 , i} ) ]$$
wherein T is the evolution time of the equivalent weighted projection model under the sequential evolution rules 1-4; L^{H}^{₁} is the weighted Laplacian matrix of the first group; and L^{H}^{₂} is the weighted Laplacian matrix of the second group;
step 3.2: letting x_{1,S} and x_{2,S} represent synchronization state variables of the first group and the second group respectively, and studying dynamical equations of perturbation vectors δx_{l,i}=x_{l,i}−x_{1,S} and δx_{2,i}=x_{2,i}−x_{2,S}, thereby obtaining a linearized equation from formula (6):
$$δ {\dot{x}}_{1 , i} = JF ( {x}_{1 , S} ) δ {x}_{1 , i} - σ {\sum }_{{j = 1}^{}}^{N} {\overline{L}}_{ij}^{{H}_{1}} JG ( {x}_{1 , S} ) δ {x}_{1 , j} + λ [ JH ( {x}_{2 , S} ) δ {x}_{2 , i} - JG ( {x}_{1 , S} ) δ {x}_{1 , i} ] \qquad ( 7 )$$
$$δ {\dot{x}}_{2 , i} = JF ( {x}_{2 , S} ) δ {x}_{1 , i} - σ {\sum }_{j = 1}^{N} {\overline{L}}_{ij}^{{H}_{2}} JG ( {x}_{2 , S} ) δ {x}_{2 , j} + λ [ JH ( {x}_{1 , S} ) δ {x}_{1 , i} - JH ( {x}_{2 , S} ) δ {x}_{2 , i} ]$$
wherein J is a Jacobi operator;
assuming that L̅^{H}^{₁} and L̅^{H}^{₂} are interchangeable, L̅^{H}^{₁} and L̅^{H}^{₂} are diagonalized under the same basis, L̅^{H}^{₁} and L̅^{H}^{₂} share a group of eigenvectors vᵢi=1, . . . , N, and a matrix composed of the eigenvectors is denoted as V=[v₁, v₂, . . . , v_{N}], then
$${Λ}_{1} = {V}^{- 1} {\overline{L}}^{{H}_{1}} V = diag \{ 0 = {γ}_{1} \leq {γ}_{2} \leq … \leq {γ}_{N} \}$$
$${Λ}_{2} = {V}^{- 1} {\overline{L}}^{{H}_{2}} V = diag \{ 0 = {ρ}_{1} \leq {ρ}_{2} \leq … \leq {ρ}_{N} \}$$
$$δ {x}_{1} = {[ δ {x}_{1 , 1}^{T} , δ {x}_{1 , 2}^{T} , … , δ {x}_{1 , N}^{T} ]}^{T} and δ {x}_{2} = {[ δ {x}_{2 , 1}^{T} , δ {x}_{2 , 2}^{T} , … , δ {x}_{2 , N}^{T} ]}^{T}$$
are introduced; and δxₗ is projected on V and denoted as ξ^{(l)}=(V⁻¹⊗I_{d})δxₗ, wherein I_{d} represents a unit matrix, thereby obtaining a master stabilizing equation:
$${ξ}_{i}^{( 1 )} = JF ( {X}_{1 , S} ) {ξ}_{i}^{( 1 )} - {σγ}_{i} JG {ξ}_{i}^{( 1 )} + λ [ JH ( {x}_{2 , S} ) {ξ}_{i}^{( 2 )} - JH ( {x}_{1 , S} ) {ξ}_{i}^{( 1 )} ] \qquad ( 8 )$$
$${ξ}_{i}^{( 2 )} = JF ( {x}_{2 , S} ) {ξ}_{i}^{( 2 )} - {σρ}_{i} JG {ξ}_{i}^{( 2 )} + λ [ JH ( {x}_{1 , S} ) {ξ}_{i}^{( 1 )} - JH ( {x}_{2 , S} ) {ξ}_{i}^{( 2 )} ]$$
wherein
$${ξ}_{1}^{( l )}$$
represents motion along intra-group synchronization manifold, and other
$${ξ}_{i}^{( l )}$$
represents evolution of different modes intersecting synchronization manifold; and through the master stabilizing equation and an equation satisfied by nonlinear synchronization solutions:
$${\dot{x}}_{1 , S} = F ( {x}_{1 , S} ) + λ [ H ( {x}_{2 , S} ) - H ( {x}_{1 , S} ) ] \\ {\dot{x}}_{2 , S} = F ( {x}_{2 , S} ) + λ [ H ( {x}_{1 , S} ) - H ( {x}_{2 , S} ) ] \qquad ( 9 )$$
the largest transverse Lyapunov exponents of two subequations in the master stabilizing equation are calculated respectively:
$${Ω}_{1} ( σ , λ , {Λ}_{1} ) = {〈 {lim}_{t \to 0} \frac{1}{t} ln \vert {ξ}_{i}^{( 1 )} {ξ}_{i}^{( 1 )} ( 0 ) \vert 〉}_{ma x}^{1} \\ {Ω}_{2} ( σ , λ , {Λ}_{2} ) = {〈 {lim}_{t \to 0} \frac{1}{t} ln \vert {ξ}_{i}^{( 2 )} {ξ}_{i}^{( 2 )} ( 0 ) \vert 〉}_{m ax}^{2} \qquad ( 10 )$$
wherein
$${ξ}_{i}^{( 1 )} ( 0 ) and {ξ}_{i}^{( 2 )} ( 0 )$$
represent initial values of the master stabilizing equation, and [symbol] [symbol] ₘₐₓ^{l} represents the maximum value obtained when i traverses all the nodes in the group; the necessary conditions for the time approximate equation to achieve linear stability are Ω₁<0 and Ω₂<0; when the inter-group coupling strength λ is constant, the intra-group synchronization critical coupling strength is obtained according to Ω₁=0 and Ω₂=0; and the time when the system achieves intra-group synchronization errors less than the threshold value 10⁻⁵ for the first time is recorded as the intra-group synchronization critical time, and the value thereof is given by numerical simulation according to formula (5);
step 3.3: according to the time approximate equation and formula (9), obtaining an error equation:
$$\{ \begin{matrix}δ {\dot{x}}_{1 , j} = F ( {x}_{1 , i} ) - F ( {x}_{1 , S} ) - σ {\sum }_{j = 1}^{N} {\overline{L}}_{ij}^{{H}_{1}} G ( δ {x}_{1 , j} ) + λ H ( δ {x}_{2 , i} - δ {x}_{1 , j} ) \\ δ {\dot{x}}_{2 , i} = F ( {x}_{2 , i} ) - F ( {x}_{2 , S} ) - σ {\sum }_{j = 1}^{N} {L}_{ij}^{{H}_{2}} G ( δ {x}_{2 , j} ) + λ H ( δ {x}_{1 , i} - δ {x}_{2 , i} )\end{matrix} \qquad ( 11 )$$
a Lyapunov function is constructed: Y(t)=Y₁(t)+Y₂(t), wherein
$${Y}_{1} ( t ) = \frac{1}{2} {\sum }_{i = 1}^{N} {( δ {x}_{1 , i} )}^{T} δ {x}_{1 , i} , \\ and \\ {Y}_{2} ( t ) = \frac{1}{2} {\sum }_{i = 1}^{N} {( δ {x}_{2 , i} )}^{T} δ {x}_{2 , i} ;$$
a constant M is set as the Lipschitz constant of the function
$$F ( \cdot ) , \\ \overline{L} = ( \begin{matrix}{\overline{L}}^{{H}_{1}} & 0 \\ 0 & {\overline{L}}^{{H}_{2}}\end{matrix} ) ∈ {R}^{2 N \times 2 N} , \\ Q = ( \begin{matrix}- {I}_{N} & {I}_{N} \\ {I}_{N} & - {I}_{N}\end{matrix} ) ,$$
and δx=[(δx₁)^{T}, (δx₂)^{T}]∈R^{2dN}; I_{N}, I_{2N} and I_{2dN} represent unit matrixes of N×N, 2N×2N and 2dN×2dN respectively; and through calculation,
$$\dot{Y} ( t ) \leq {M ( δ x )}^{T} δ x - {σ ( δ x )}^{T} ( \overline{L} ⊗ G ) δ x - {d ( δ x )}^{T} ( {I}_{2 N} ⊗ H ) δ x + {λ ( δ x )}^{T} [ ( {I}_{2 N} ( \begin{matrix}0 & {I}_{N} \\ {I}_{N} & 0\end{matrix} ) ) ⊗ H ] δ x = {( δ x )}^{T} [ {MI}_{2 dN} - σ ( \overline{L} ⊗ G ) λ ( Q ⊗ H ) ] δ x \qquad ( 12 )$$
it is noted that a matrix v exists so that Λ=V⁻¹L̅V, wherein Λ is a diagonal matrix composed of γᵢ and ρᵢ,
$$0 = {γ}_{1} \leq {γ}_{2} \leq … \leq {γ}_{N} , and 0 = {ρ}_{1} \leq {ρ}_{2} \leq … \leq {ρ}_{N} ; \\ ξ = ( {V}^{- 1} ⊗ {I}_{d} ) δ x = {( {ξ}_{1}^{T} , {ξ}_{2}^{T} , … , {ξ}_{2 N}^{T} )}^{T} ,$$
wherein ξᵢ is a d-dimensional vector; and
$$σ = {σ}_{0} + 1 = \frac{1}{{\partial }_{2} ( Λ ⊗ G )} ( M + λ {\partial }_{ma x} ( ( {V}^{- 1} Q V ) ⊗ H ) ) + 1 ,$$
thereby obtaining:
$$\dot{Y} ( t ) \leq M {ξ}^{T} ξ - σ {ξ}^{T} ( Λ ⊗ G ) ξ + ) {ξ}^{T} ( ( {V}^{- 1} QV ) ⊗ H ) ξ = - {\partial }_{2} ( Λ ⊗ G ) {( δ x )}^{T} δ x \qquad ( 13 )$$
wherein ∂₂(Λ⊗G) represents the second minimum eigenvalue of Λ⊗G, and ∂ₘₐₓ((V⁻¹ [symbol] V)⊗H) represents the largest eigenvalue of (V⁻¹ [symbol] V)⊗H; global synchronization criteria are determined by
$${σ}_{0} = \frac{1}{{\partial }_{2} ( Λ ⊗ G )} ( M + λ {\partial }_{ma x} ( ( {V}^{- 1} Q V ) ⊗ H ) ) ;$$
and when σ>σ₀, the hypergraph multi-agent grouping system realizes global intra-group synchronization;
the relationship between stochasticity and synchronizability of the model is verified by numerical experiments combined with necessary conditions for the linear stability obtained in step 3 and the global synchronization criteria as well as the three indexes of intra-group synchronization errors, intra-group synchronization critical time and intra-group synchronization critical coupling strength designed in step 2.
